(19) United States
(12) Patent Application Publication
(10) Pub. No.: US 2008/0031237 A1
(43) Pub. Date: Feb. 7, 2008

(54) Internet media server finding and playing methodologies

(76) Inventor: Tsu-Hung Liu, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/497,394

(22) Filed: Aug. 2, 2006

(51) Int. Cl. H04L 12/56

(52) U.S. Cl. 370/389; 370/401

(57) ABSTRACT

The invention relates to Internet media server finding and playing methodologies, wherein media client can find out media server in the Internet under NAT or not under NAT by using conventional Domain Name Server and SIP Proxy Server. And the methodology especially has valid media streaming played by media client when media server is under NAT. Users can only use a single name or number to find out the media server and play the media provided by the server easily and conveniently that obtains utilization and improvement.

### BACKGROUND OF THE INVENTION

Under public Internet Environment, most of the media servers link to the Internet via PPPoE (Point to Point Protocol over Ethernet) or DHCP (Dynamic Host Configuration Protocol) client without fixed static IP, and even with static IP, it is hard to remember the IP. In some worse environment, the media server or the media client is not linked to the Internet directly but under NAT (Network Address Translator). In such case, the media client is impossible to link the media server without the outside help. The port forwarding method set in the NAT router may resolve such issue. But if the router connected to the Internet is via PPPoE or DHCP client, the server cannot be found by client. And to set the port forwarding in the NAT router is infeasible for most of the users.

The media server may register to the Domain Name Server in the public Internet to resolve the media server finding issue. But it will be impossible for Domain Name setup if the media client is under NAT. The complete solution may be resolved by SIP (Session Initial Protocol) Server and STUN (Simple Traversal of UDP over NAT) Server in the public internet and related operation in the media client. But there are two disadvantages: a. the media stream play uses SDP (Session Description Protocol) but not popular RTSP. b. The corresponding SIP plus STUN operation in the client needs more memory/process and is not effective.

### SUMMARY OF THE INVENTION

The present invention relates to Internet media server finding and playing methodologies, which includes a primary objective in proposing the efficient and complete methodology to resolve the above issues and disadvantages. With this methodology, the media client can easily find the media server and play the media provided by the server either the server is connected to the public Internet or under NAT. By using the methodology of the present invention, users do not need to set up the media server or media client parameters for server finding and NAT penetration of streaming. So it is very useful for most of the users who are unfamiliar with network operation. Now, accompanying with the following drawings, the character of the present invention will be described here and after.

### BRIEF DESCRIPTION OF THE DRAWINGS

FIG. 1 is a framework view showing an embodiment of an Internet media server finding and playing methodology having Media Serve under the NAT according to the present invention.

FIG. 2 is a framework view showing an embodiment of an Internet media server finding and playing methodology having Client Serve under the NAT according to the present invention.

FIG. 3 is a framework view showing Software architecture of an Internet media server finding and playing methodology for Media Server according to the present invention.

FIG. 4 is a framework view showing Software architecture of an Internet media server finding and playing methodology for Media Client according to the present invention.

FIG. 5 is a flowchart showing a DN/SIP Notify method procedure in Media Server according to the present invention.

FIG. 6 is a flowchart showing an IP/Port Finder method procedure in Media Client according to the present invention.

### DETAILED DESCRIPTION OF THE PREFERRED EMBODIMENT

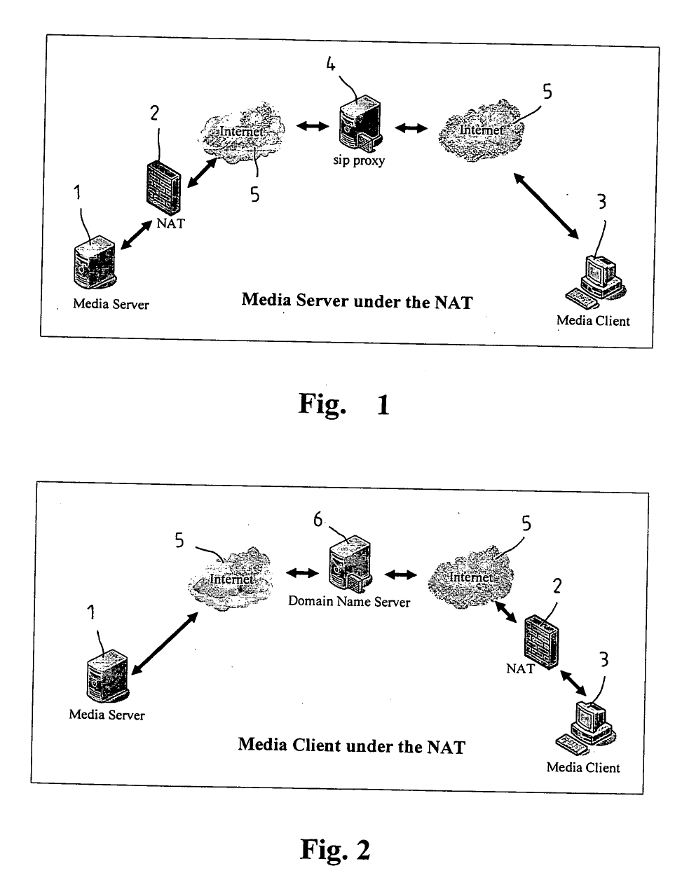

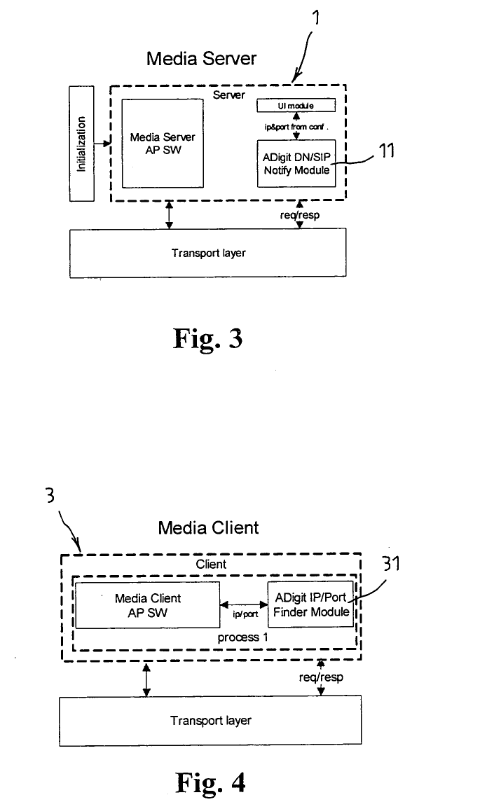

Referring to FIG. 1 and 2, the present invention relates to an Internet media server finding and playing methodology, which may include two conditions when under NAT (2), wherein one is the Media Server (1) under NAT (2) (FIG. 1) or the other is the Media Client (3) under NAT (2) (FIG. 2). In these embodiments, the standard Domain Name Server (6) and SIP Proxy Server (4) is used without modification of these Servers. The character of the present invention is to provide an original standard DN/SIP (Domain Name registrar and Session Initial Protocol) Notify Module (11) for SIP registrar and media streaming penetration in the Media Server (1), as shown in FIG. 3. An IP/Port Finder Module (31) is resident in the media client (3) to provide the IP and port numbers of the media server (1), as in FIG. 4.

Each media server (1) will be identified by a unique same ID for both Domain Name (such as 1234567890.adigit.ipav.com.tw or mary@yahoo.com.tw.adigit.ipav.com.tw) and SIP account (i.e. 1234567890 or many@yahoo.com.tw). The user can distinguish the media client (3) by the same ID name (many@yahoo.com.tw) or number (1234567890).

When the media server (1) is powered on, it will try to register the Domain Name ID to the dedicated public Internet (5) DNS (6). If it is successful, the media server (1) certifies itself connecting to public Internet (5) directly. The media client (3) may find the server (1) through the prefix of the server Domain Name (i.e. 1234567890 or mary@yahoo.com.tw). The fix part of the domain name (i.e. adigit.ipav.com.tw) is saved in the media client (3) in advance. So only the first prefix number (1234567890) or name (mary@yahoo.com.tw) is needed to remember by users.

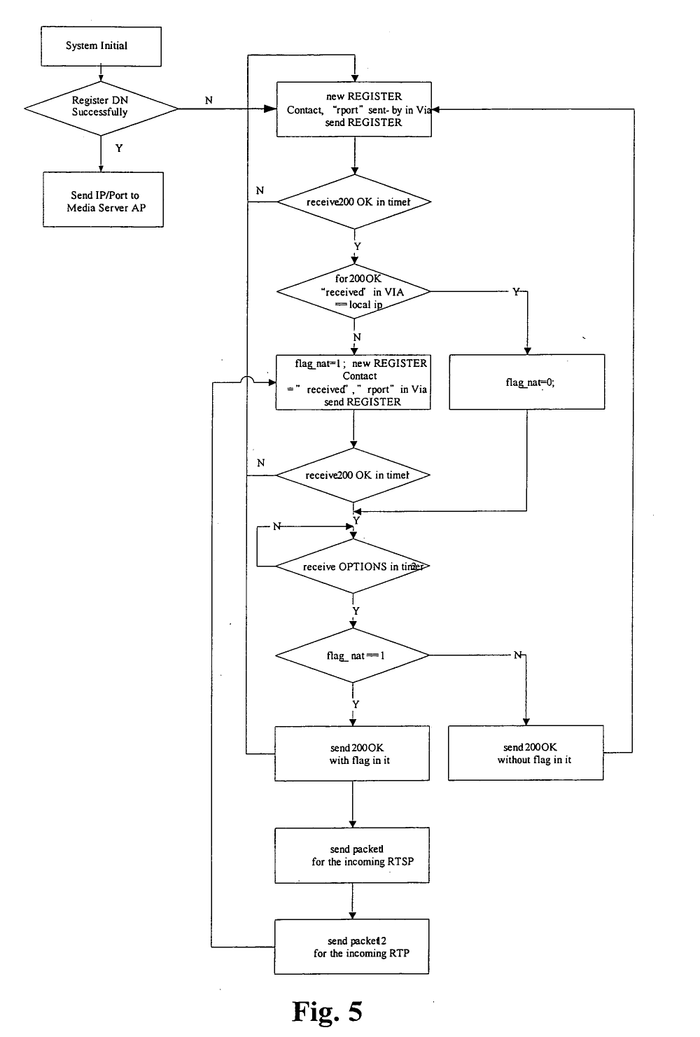

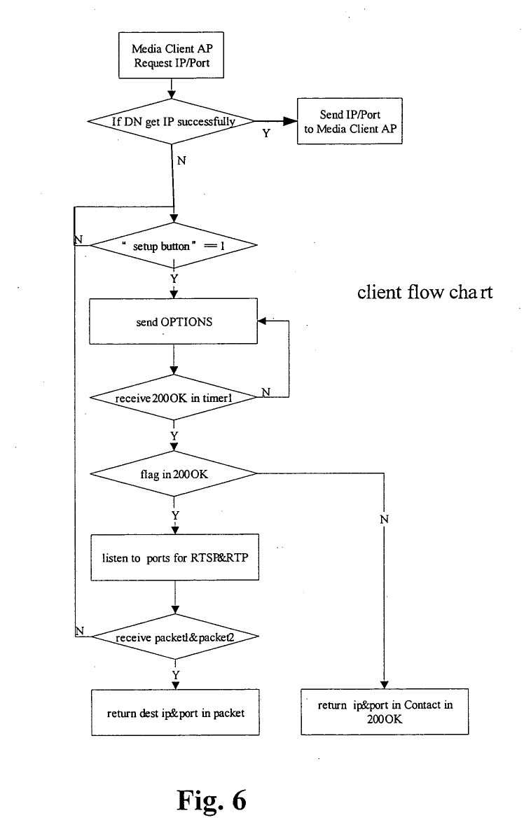

If the media server (1) domain name is failure to register, the media server (1) certifies itself to be under NAT (2). In this case, the SIP Proxy Server (4) shall be used for the media client (3) to find out the media server (1) and play the media provided by server (1). The operation of the media client/server uses SIP OPTION procedures to link media server and client together for command communication (RTSP, Real Time Streaming Protocol) and the NAT (2) port penetration for following media play (RTP, Real Time Transport Protocol). The detailed procedure flows are described in FIG. 5 for media server (1) and FIG. 6 for media client (3) respectively. Referring to FIG. 5, the procedures are as following:
1. After the initialization, the Media Server registers to the Domain Name Server (DN). If it is successful, then exits. If it is failure then goes to the SIP registrar procedure.
2. The Media Server registers to the SIP Proxy Server with received port (rport) number set in the Via field.
3. If Media Server receives 200 OK message from SIP Proxy Server then checks if the received IP is the same as local WAN IP. If it is then it is confirmed that Media Server is connected to public Internet directly.
4. Otherwise, Media Server is under NAT. In this case, Media Server will register to SIP Proxy Server again with the new received IP/port number.
5. After completing registrar, Media Server is waiting for the message of SIP Options sent from Media Client.
6. When receiving the Options message, Media Server will response with 200 OK message to SIP Proxy Server with NAT flag set to 1 (Media Server under NAT) or 0 (Media Server is not under NAT).
7. For NAT flag=0, the Media Client can connect to Media Server and play media directly
8. For NAT flag=1, the packets for RTSP and RTP penetrating NAT are sent out so the Media Client can connect the Media Server which is under NAT and plays media.

Referring to FIG. 6, the procedures are as following steps:
1. When the Media Client is ready for playing media from Media Server, It first queries the Media Server IP address from Domain Name Server. If it is successful, then Media Client can play media from Media Server directly with predefined IP/port number. Otherwise the Media Client will go to the SIP procedure.
2. In SIP procedure, Media Client will send Options message to Media Server via SIP Proxy Server first and waiting for the response from Media Server.
3. Media Server sends 200 OK back to Media Client with NAT flag status in the message.
4. For NAT flag equals to 0, Media Client will connect to the Media Server directly. The IP/port number is provided by Media Server in the SIP 200 OK message.
5. For NAT flag equals to 1, Media Client will listen to the packets of RTP/RTSP sent from Media Server. After receiving the packets, Media Client can play media from Media Server. The IP/port number is provided by Media Server in the SIP 200 OK message.

But these two flowcharts are only exemplary and not to limit the scope of the present invention. It is also to be understood any modification with the same or similar merit is still claimed in this application.

Above all, it can be found that the accommodated Domain Name and SIP methodology can be redundancy and will make the finding and playing system more safely. Using Domain Name method first then SIP method will make the finding system more efficiently. Using only a single name or number to find out the media server and play the media provided by the server is critical and requested by Internet users. The methodology of the present invention can fulfill these requirements. Hence, the present invention obviously obtains improvement and should be allowed for a patent.

I claim:

1. An Internet media server finding and playing methodology using conventional Domain Name Server and SIP Proxy Server to find out media server in the Internet, and when media server is under NAT, the operation of the media client/server using SIP OPTION procedures to link media server and client together for command communication (RTSP) and the NAT port penetration for following media play (RTP) to have valid media streaming played by media client.

2. The Internet media server finding and playing methodology as claimed in claim 1, wherein the procedure including media server checks the valid of domain by Domain Name registrar or private IP first then the valid of SIP registrar using the same user identified name or number.

3. The Internet media server finding and playing methodology as claimed in claim 1, wherein the procedure includes that the media client tries to find the media server by the user identified name with domain method first then tries to find the media server by using the same user identified name with SIP method if the first method is failure.

4. The Internet media server finding and playing methodology as claimed in claim 1, wherein the media client only uses one number or name to find media server and the following media play.

5. An Internet media server finding and playing methodology using conventional Domain Name Server and SIP Proxy Server to find out media server in the Internet, and when media server is connected to public Internet, the media server will register the Domain Name ID to the dedicated public Internet DNS directly as power is on and has valid media streaming played by media client.

6. The Internet media server finding and playing methodology as claimed in claim 5, wherein the procedure including media server checks the valid of domain by Domain Name registrar or private IP first then the valid of SIP registrar using the same user identified name or number.

7. The Internet media server finding and playing methodology as claimed in claim 5, wherein the procedure includes that the media client tries to find the media server by the user identified name with domain method first then tries to find the media server by using the same user identified name with SIP method if the first method is failure.

8. The Internet media server finding and playing methodology as claimed in claim 5, wherein the media client only uses one number or name to find media server and the following media play.
